(19) United States
(12) Patent Application Publication
(10) Pub. No.: US 2026/0249746 A1
(43) Pub. Date: Aug. 27, 2026

(54) POWERED PINION ZERO GRAVITY DRIVE MECHANISM

(71) Applicant: Ford Global Technologies, LLC, Dearborn, MI (US)

(72) Inventors: Patrick Maloney, Livonia, MI (US); Marc Silva Kondrad, Macomb Township, MI (US); Kevin VanNieulande, Fraser, MI (US)

(73) Assignee: Ford Global Technologies, LLC, Dearborn, MI (US)

(21) Appl. No.: 19/061,331

(22) Filed: Feb. 24, 2025

(51) Int. Cl. B60N 2/02; B60N 2/18

(52) U.S. Cl. CPC B60N 2/02253; B60N 2/181

(57) ABSTRACT

A vehicle seating assembly includes a zero-gravity drive mechanism configured to transition a vehicle seat into a zero-gravity configuration that includes a first tilt assembly, a second tilt assembly, a pivotable link, and a rear sectored link. Both the first and second tilt assemblies include a sectored link configured to pivot at two pivot points relative to an insertion tube of the seating assembly and a mount plate pivotably coupled with the sectored link of each pivot assembly. A cross-shaft extends laterally between the first and second tilt assembly and is coupled with a first pinion at a first end of the cross-shaft and a second pinion at a second end of the cross-shaft. An actuator is coupled with and configured to rotate the cross-shaft, effectuating a simultaneous rotation of the pinions against the sectored links, driving the tilt assemblies to transition the seat to the zero-gravity configuration.

### FIELD OF THE DISCLOSURE

The present disclosure generally relates to a zero-gravity drive mechanism for a vehicle seating assembly.

### BACKGROUND OF THE DISCLOSURE

The present concepts provide a modular and efficient means to enable a user to transition a vehicle seat into a zero-gravity configuration. A zero-gravity configuration places the user in an enhanced posture for relaxation and comfort.

### SUMMARY OF THE DISCLOSURE

According to a first aspect of the present disclosure, a vehicle seating assembly comprises a seat base, a seat back, an insertion track, a cross-shaft with a first end and a second end, a first mount plate coupled to the first end of the cross-shaft; and a first sectored link coupled to the first end of the cross-shaft, wherein the first sectored link is pivotally coupled to the insertion track at a first pivot point, and the first sectored link is pivotally coupled to the first mount plate at a second pivot point, and wherein the first sectored link is configured to move the seat base between a neutral configuration and a zero-gravity configuration.

Embodiments of the first aspect of the present disclosure can include any one or a combination of the following features:

The vehicle seating assembly may further comprise a second mount plate coupled to the second end of the cross-shaft, a second sectored link coupled to the second end of the cross-shaft, wherein the second sectored link is pivotally coupled to the insertion track at a third pivot point, and the second sectored link at a fourth pivot point.

The first sectored link may be pivotally coupled to a front portion of the insertion track.

The first sectored link may be pivotally coupled to a seat bracket.

The first sectored link may have an arcuate leg that defines a toothed edge configured to mesh with a first pinion coupled to the first end of the cross-shaft.

The first sectored link may define an arcuate aperture.

The first mount plate may define a drive aperture that extends between a first side of the first mount plate and a second side of the first mount plate, wherein a first pinion is coupled with the first side of the first mount plate, and the first end of the cross-shaft is coupled with the first pinion via the drive aperture.

The vehicle seating assembly may further comprise an actuator coupled to the cross-shaft and configured to rotate the cross-shaft about a lateral axis defined by the cross-shaft.

The vehicle seating assembly may further comprise a first pinion coupled with the first end of the cross-shaft, a second pinion coupled with the second end of the cross-shaft, and an actuator coupled with the cross-shaft.

The vehicle seating assembly may further comprise a first stop bolt coupled with a first side of the first mount plate and interposed between the second pivot point and a first pinion.

The first stop bolt, the second pivot point, and the first pinion may be substantially aligned along an axis defined by a second edge of the first mount plate.

According to a second aspect of the present disclosure, a vehicle seating assembly comprises a seat base, a seat back, an insertion track, a cross-shaft with a first end and a second end, a first mount plate coupled to the first end of the cross-shaft, a second mount plate coupled to the second end of the cross-shaft, a first sectored link coupled to the first end of the cross-shaft, wherein the first sectored link is pivotally coupled to the insertion track at a first pivot point, and the first sectored link is pivotally coupled to the first mount plate at a second pivot point, and a second sectored link is coupled to the second end of the cross-shaft, wherein the second sectored link is pivotally coupled to the insertion track at a third pivot point, and the second sectored link is pivotally coupled to the second mount plate at a fourth pivot point, and wherein the first and second sectored links are configured to move the seat base between a neutral configuration and a zero-gravity configuration.

Embodiments of the second aspect of the present disclosure can include any one or a combination of the following features:

The first sectored link and the second sectored link may be pivotally coupled to a front portion of the insertion track.

The first mount plate and the second mount plate may be coupled to a seat bracket.

The vehicle seating assembly may further comprise a first pinion coupled with the first end of the cross-shaft and a second pinion coupled with the second end of the cross-shaft.

The vehicle seating assembly may further comprise an actuator coupled to the cross-shaft and configured to rotate the cross-shaft about a lateral axis defined by the cross-shaft.

The first sectored link may be configured to pivot about a lateral axis defined by the first pivot point and to pivot about a lateral axis defined by the second pivot point, and the second sectored link may be configured to pivot about a lateral axis defined by the third pivot point and to pivot about a lateral axis defined by the fourth pivot point.

According to a third aspect of the present disclosure, a vehicle seating assembly comprises a sliding assembly, a seat bracket, a cross-shaft with a first end and a second end, a first mount plate coupled to the first end of the cross-shaft and the seat bracket, and a first sectored link coupled to the first end of the cross-shaft, wherein the first sectored link is pivotally coupled to the sliding assembly at a first pivot point, and the first sectored link is pivotally coupled to the first mount plate at a second pivot point, and wherein the first sector link and the sliding assembly are configured to move the seat base between a neutral configuration and a zero-gravity configuration.

Embodiments of the third aspect of the present disclosure can include any one or a combination of the following features:

The vehicle seating assembly may further comprise a second mount plate coupled to the second end of the cross-shaft and the seat bracket, a second sectored link coupled to the second end of the cross-shaft, wherein the second sectored link is pivotally coupled to the insertion track at a third pivot point, and the second sectored link is pivotally coupled to the second mount plate at a fourth pivot point.

The vehicle seating assembly may further comprise a first pinion coupled to the first end of the cross-shaft and meshed with a toothed edge of the first sectored link, a second pinion coupled to the second end of the cross-shaft and meshed with a toothed edge of the second sectored link, and an actuator coupled to the second end of the cross-shaft, wherein the actuator is configured to rotate the cross-shaft about a lateral axis defined by the cross-shaft to tilt a front portion of the seat bracket from a first position to a second position.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a perspective view of a passenger compartment of a vehicle containing a vehicle seating assembly;

FIG. 2 is an exploded view of the vehicle seating assembly;

FIG. 3 is a perspective view of a sliding assembly of the vehicle seating assembly;

FIG. 4 is a perspective view of an insertion track of the sliding assembly;

FIG. 5 is an exploded view of the vehicle seating assembly with a zero-gravity mechanism;

FIG. 6 is a perspective view of a first tilt assembly of the zero-gravity mechanism;

FIG. 7 is an exploded view of the first tilt assembly;

FIG. 8A is a perspective view of the first tilt assembly in a neutral configuration A;

FIG. 8B is a perspective view of the first tilt assembly in a zero-gravity configuration B;

FIG. 9 is a perspective view of a second tilt assembly of the zero-gravity mechanism;

FIG. 10 is an exploded view of the second tilt assembly;

FIG. 11A is a perspective view of the second tilt assembly in a neutral configuration A;

FIG. 11B is a perspective view of the second tilt assembly in a zero-gravity configuration B;

FIG. 12 is a perspective view of a pivotable link of the zero-gravity assembly;

FIG. 13 is a perspective view of a rear sector gear of the zero-gravity assembly;

FIG. 14 is an exploded view of the seating assembly with a diagram illustrating a control system for the zero-gravity mechanism;

FIG. 15A is a perspective view of the seating assembly in a neutral configuration A; and

FIG. 15B is a perspective view of the seating assembly in a zero-gravity configuration B.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

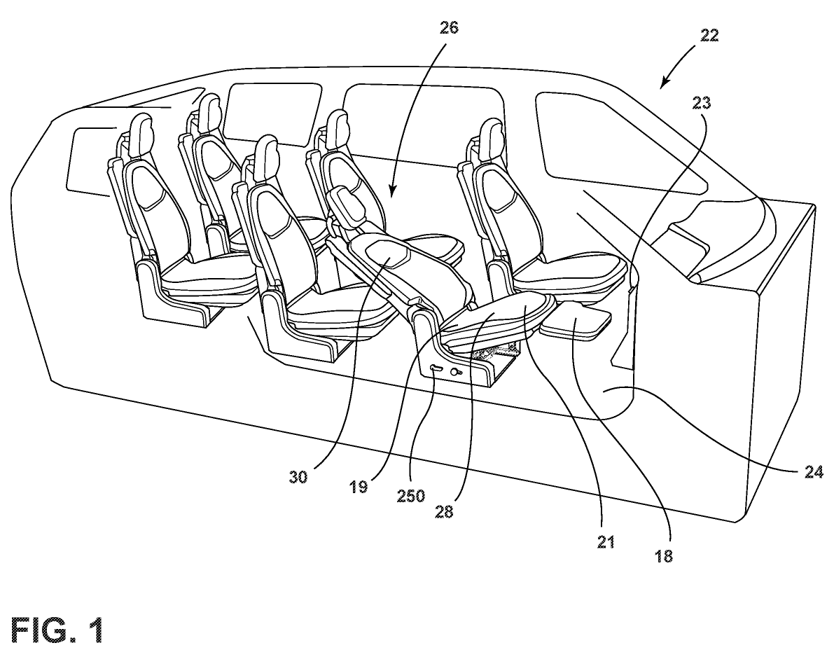

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a zero-gravity drive mechanism for a vehicle seating assembly. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIGS. 1-15, reference numeral 20 generally designates a seating assembly 20 for a vehicle 22. The seating assembly 20 is configured to be coupled to a floor 24 of the vehicle 22. The vehicle seating assembly 20 includes a seat bracket 25 that provides attachment points for a user accommodation 26, wherein the user accommodation 26 may comprise a seat base 28, a seat back 30, and a leg support 18. The seat base 28 includes a forward end 32 and a rearward end 34. The seat back 30 is rotatably coupled to the seat base 28 proximate the rearward end 34. The leg support 18 is rotatably coupled to the seat base 28 proximate the forward end 32. The leg support 18 is movable between a retracted position and an extended position and may remain in an intermediate position between the retracted position and the extended position. The vertical position of the user accommodation 26 relative to the floor 24 of the vehicle 22 may be adjusted by a user of the seating assembly 20. The incline of the seat base 28 relative to the floor 24 of the vehicle 22 may be adjusted, such that a front portion 21 of the seat base 28 is positioned higher than a rear portion 19 of the seat base 28 relative to the floor 24 of the vehicle 22. Together, the combination of movement between the seat base 28, seat back 30, and leg support 18 may cooperate to position the user accommodation 26 into a zero-gravity configuration. In the zero-gravity configuration, the user within the user accommodation 26 may be positioned within a neutral body posture, wherein the legs of the user may be elevated above the heart of the user.

Referring to FIG. 1, the vehicle seating assembly 20 may be positioned within the vehicle 22. For example, the vehicle seating assembly 20 may be positioned within a passenger compartment of the vehicle 22. The vehicle 22 may be a motor vehicle. For example, the vehicle 22 may be a land-based vehicle (e.g., an automobile, a motorcycle, a train, etc.), or an air-based vehicle (e.g., a plane or other aircraft). While the vehicle 22 may be a motor vehicle, the present disclosure is not limited to internal combustion engines as a source of locomotive power to the vehicle 22. For example, locomotive power may be provided to the vehicle 22 by electric motors, fuel cells, and/or petroleum-based fuel engines. According to various examples, a semi-autonomous example of the vehicle 22 may perform many, or all, commuting functions (e.g., braking, turning, signaling, etc.) independent of user interaction while the user maintains override control of the vehicle 22. The zero-gravity configuration of the user accommodation 26 may be intended for use when the vehicle 22 is in a stationary (i.e., non-moving state). However, while all modern OEMS of passenger vehicles currently advise occupants against reclining the user accommodation past a certain angle while the vehicle 22 is moving due to safety concerns, it is anticipated that technology and the regulatory framework may evolve in the future where such activity, such as vehicle in autonomous drive mode is permissible.

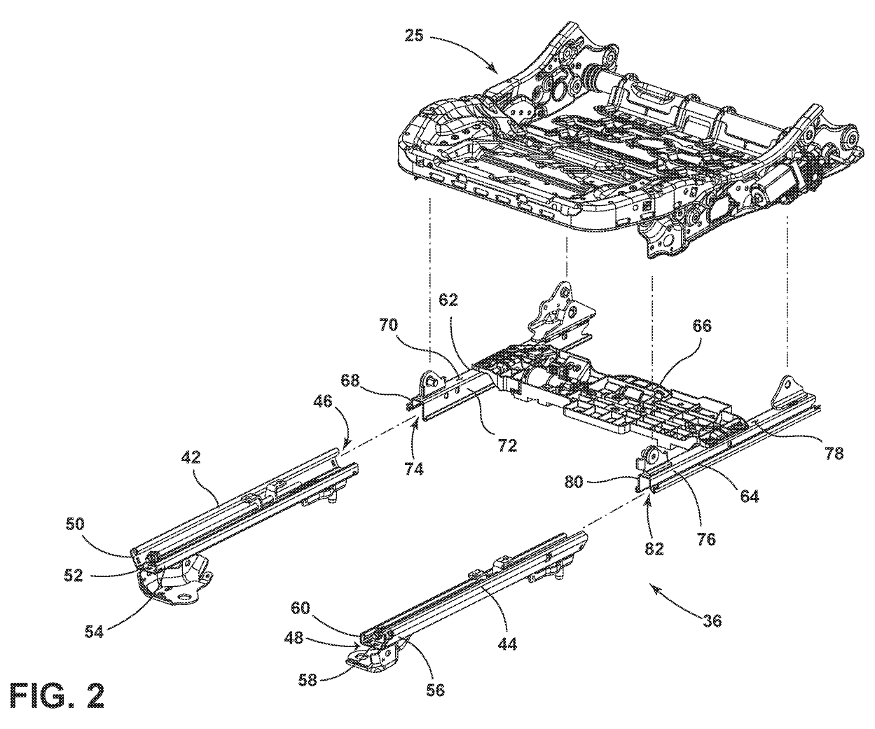

Referring to FIG. 2, the vehicle seating assembly 20 may be coupled to the floor 24 of the vehicle 22 via a sliding assembly 36. The sliding assembly 36 may enable the user accommodation 26 to be longitudinally adjusted along a portion of the length of the vehicle 22 (e.g., fore-aft direction). The vehicle seating assembly 20 may include an insertion track 40, a first receiving track 42 and a second receiving track 44. The first 42 and the second 44 receiving tracks may be fixed to the floor 24 of the vehicle 22 via a plurality of bolts or other attachment means. The first 42 and the second 44 receiving tracks extend longitudinally at least a portion of the length of the vehicle 22 and are positioned substantially parallel to one another.

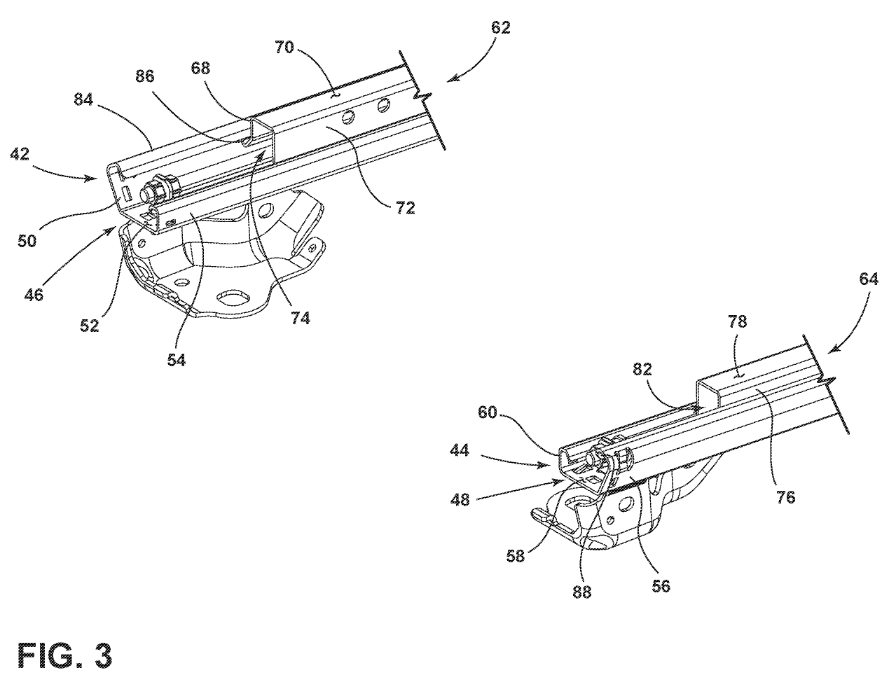

Referring now to FIGS. 2 and 3, the first receiving track 42 may form a track guide 46 that longitudinally extends at least a portion of the length of the first receiving track 42. Likewise, the second receiving track 44 may form a track guide 48 that extends down at least a portion of the length of the second receiving track 44. The track guide 46 of the first receiving track 42 may be formed from a first track wall 50, a bottom surface 52, and a second track wall 54 that cooperate to provide the track guide 46 with a substantially U-shaped cross-sectional profile. The track guide 48 of the second receiving track 44 may likewise be formed from a first track wall 56, a bottom surface 58, and a second track wall 60 that cooperate to provide the track guide 48 with a substantially U-shaped cross-sectional profile.

Referring still to FIGS. 2 and 3, the insertion track 40 may include a first tube 62, a second tube 64, and a bridge 66 that may interconnect the first tube 62 and the second tube 64. The first tube 62 may be slidably coupled with the first receiving track 42 and may longitudinally extend in parallel to the length of the first receiving track 42. Likewise, the second tube 64 may be slidably coupled with the second receiving track 44 and may longitudinally extend in parallel to the length of the second receiving track 44. The first tube 62 may be formed from a first side 68, top surface 70, and a second side 72 that together cooperate to provide the first tube 62 with a substantially reversed U-shaped cross-sectional profile and to define a hollow interior 74 that extends therethrough the first tube 62. The second tube 64 may be formed from a first side 76, a top surface 78, and a second side 80 that together cooperate to provide the second tube 64 with a substantially reverse U-shaped cross-sectional profile and to define a hollow interior 82 that extends therethrough the second tube 64.

Referring now to FIG. 3, the first tube 62 may be slidably coupled to the track guide 46 of the first receiving track 42 via the interposition of the first side 68 and second side 72 of the first tube 62 within the track guide 46 of the first receiving track 42. Specifically, the first side 68 of the first tube 62 may be interfaced with the first track wall 50 of the track guide 46 of the first receiving track 42. Additionally, an overhang 84 formed by the first track wall 50 may slidably interface with a hook 86 formed by the first side 68 of the first tube 62. Likewise, the second tube 64 may be slidably coupled to the track guide 48 of the second receiving track 44 via the interposition of the first side 76 and the second side 80 of the second tube 64 within the track guide 48 of the second receiving track 44. Specifically, the first side 76 of the second tube 64 may be interfaced with the first track wall 56 of the track guide 48 of the second receiving track 44. Additionally, the first tube 62 and the second tube 64 of the insertion track 40 may be removably coupled to the first receiving track 42 and the second receiving track 44 such that the sliding assembly 36 is generally a modular system.

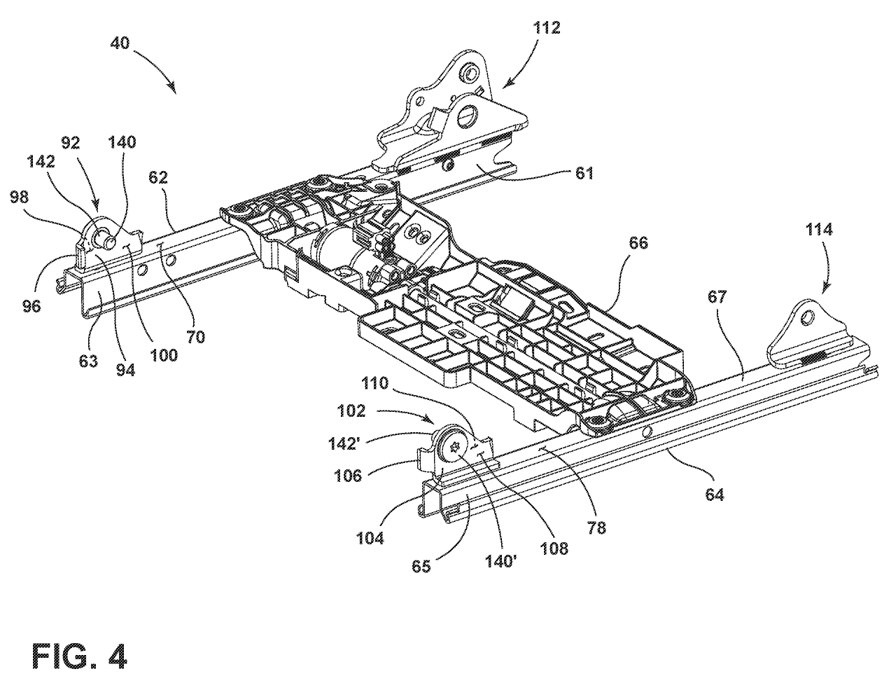

Referring now to FIG. 4, a first attachment flange 92 may be fixed to the top surface 70 of the first tube 62 and positioned at a front portion 63 of the first tube 62. The first attachment flange 92 may extend vertically from the front portion 63 of the first tube 62 towards the seat bracket 25. The first attachment flange 92 may be formed of an attachment wall 94 and a stop flange 96. The attachment wall 94 has a first surface 98 and a second surface 100 opposite the first surface 98. As shown in FIG. 4, the stop flange 96 may curl laterally from the first surface 98 towards the second surface 100 of the attachment wall 94. Alternatively, the stop flange 96 may curl laterally from the second surface 100 towards the first surface 98 of the attachment wall 94.

A second attachment flange 102 may be fixed to the top surface 78 of the second tube 64 and positioned at a front portion 65 of the second tube 64. The second attachment flange 102 may extend vertically from the front portion 65 of the second tube 64 towards the seat bracket 25. The second attachment flange 102 may be formed of an attachment wall 104 and a stop flange 106. The attachment wall 104 has a first surface 108 and a second surface 110 opposite the first surface 108. As shown in FIG. 4, the stop flange 106 may curl laterally from the first surface 108 towards the second surface 110 of the attachment wall 104. Alternatively, the stop flange 106 may curl laterally from second surface 110 to the first surface 108 of the attachment wall 104.

Still referring to FIG. 4, a third attachment flange 112 may be fixed to a rear portion 61 of the first tube 62. The third attachment flange 112 may extend vertically from the rear portion 61 of the first tube 62 towards the seat bracket 25. A fourth attachment flange 114 may be fixed to a rear portion 67 of the second tube 64. The fourth attachment flange 114 may extend vertically from the rear portion 67 of the second tube 64 towards the seat bracket 25.

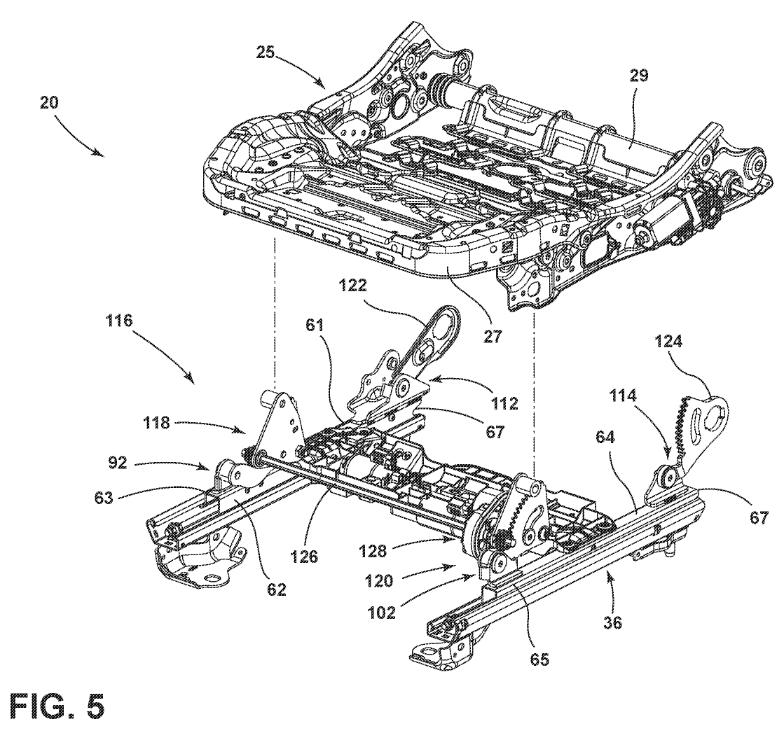

Referring now to FIG. 5, the vehicle seating assembly 20 may have a zero-gravity mechanism 116 interposed between the sliding assembly 36 and the seat bracket 25. The zero-gravity mechanism 116 may be configured to tilt the seat bracket 25, such that a front portion 27 of the seat bracket 25 is vertically transitioned away from the floor 24 of the vehicle 22, and a rear portion 29 of the seat bracket 25 is vertically transitioned towards the floor 24 of the vehicle 22. Additionally, the zero-gravity mechanism 116 may be configured to simultaneously tilt the seat bracket 25, such that both the front portion 27 of the seat bracket 25 and the rear portion 29 of the seat bracket 25 are horizontally transitioned towards the rear of the vehicle 22. The vertical and horizontal movement of the seat bracket 25, effectuated by the zero-gravity mechanism, 116 may function to transition the user accommodation 26 into the zero-gravity configuration as shown in FIG. 1.

As shown in FIG. 5, the zero-gravity assembly 116 comprises a first tilt assembly 118, a second tilt assembly 120, a pivotable link 122, a rear sectored link 124, a cross-shaft 126, and an actuator 128. The first tilt assembly 118 is coupled with the front portion 63 of the first tube 62 via the first attachment flange 92. The second tilt assembly 120 is coupled with the front portion 65 of the second tube 64 via the second attachment flange 102. The pivotable link 122 is coupled with the rear portion 61 of the first tube 62 via the third attachment flange 112. The rear sectored link 124 is coupled with the rear portion 67 of the second tube 64 via the fourth attachment flange 114. The cross-shaft 126 laterally extends between and is coupled to both the first tilt assembly 118 and the second tilt assembly 120. The actuator 128 may be coupled to the cross-shaft 126 and positioned adjacent to the second tilt assembly 120. Alternatively, the actuator 128 may be positioned adjacent to the first tilt assembly 118.

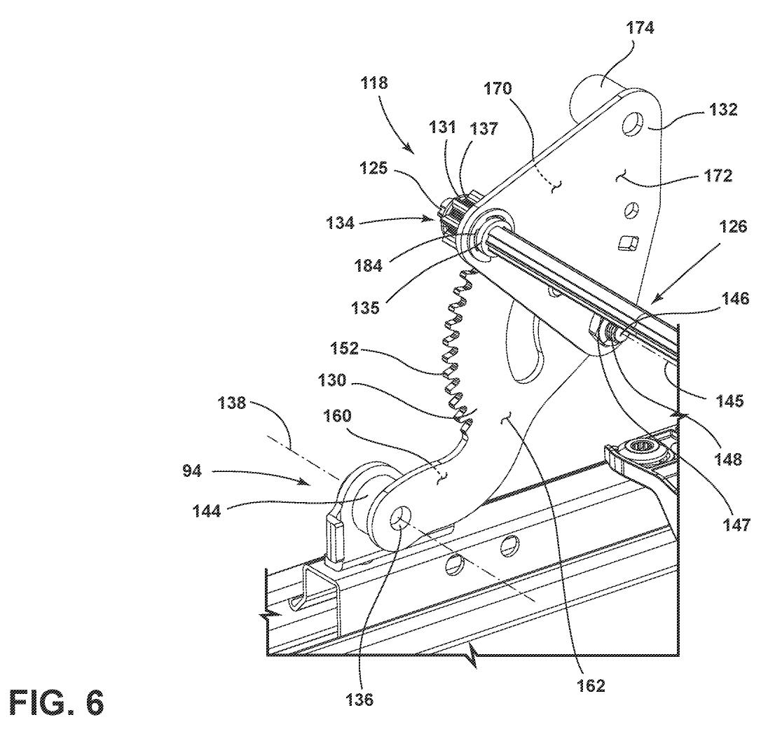

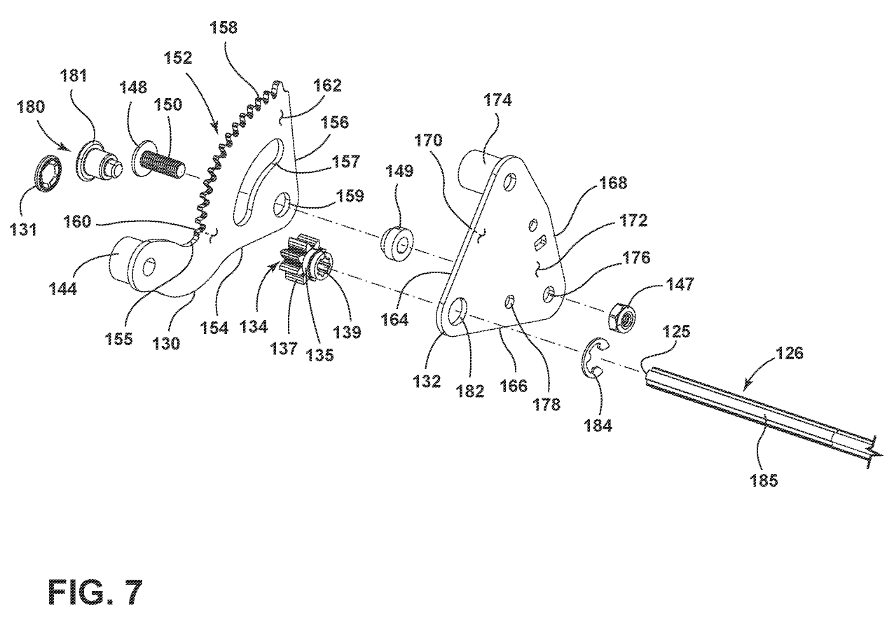

Referring now to FIGS. 6 and 7, the first tilt assembly 118 may include a first sectored link 130, a first mount plate 132, and a first pinion 134. The first sectored link 130 is pivotally coupled to the first attachment flange 92 at a first pivot point 136 and is configured to pivot relative to the first attachment flange 92 around a lateral axis 138 defined by the first pivot point 136. The first pivot point 136 may be formed by a bolt that extends through the first sectored link 130 and the first attachment flange 92, wherein the first sectored link 130 can pivot about a shaft formed by the bolt. Alternatively, as shown in FIGS. 4 and 6, the first pivot point 136 may be formed by a first attachment bolt 140 that extends from the second surface 100 of the attachment wall 94 and a receiving aperture 144 formed by the first sectored link 130. The receiving aperture 144 is configured to coaxially receive a shaft 142 of the first attachment bolt 140 and facilitate the pivoting of the first sectored link 130 through coaxial rotation of the receiving aperture 144 about the shaft 142 of the first attachment bolt 140.

The first sectored link 130 may be pivotally coupled to the first mount plate 132 at a second pivot point 146 and may be configured to pivot relative to the first mount plate 132 about a lateral axis 145 defined by the second pivot point 146. The second pivot point 146 may be formed by a first pivot bolt 148 that extends through the first sectored link 130 and the first mount plate 132, wherein the first sectored link 130 and the first mount plate 132 may pivot about a pivot shaft 150 formed by the first pivot bolt 148. A first interlink 149 may be coaxially disposed on the first pivot bolt 148 at the portion of the first pivot bolt 148 that extends between the first sectored link 130 and the first mount plate 132. Also, a first washer 147 is coaxially disposed on the portion of the first pivot bolt 148 that extends through the first mount plate 132. Additionally, the first mount plate 132 may be configured to pivot at the second pivot point 146 relative to the first sectored link 130. The first pinion 134 may be rotatably fixed to the first mount plate 132 to engage and rotate against a toothed edge 152 of the first sectored link 130.

Referring still to FIGS. 6 and 7, the first sectored link 130 of the first tilt assembly 118 may have a substantially triangular shape formed by a first leg 154, a second leg 156, and an arcuate leg 158. Further, the first sectored link 130 has a first side 160 and a second side 162 opposite the first side 160. The first leg 154 and the second leg 156 may meet at a substantially 90-degree angle. Alternatively, the first leg 154 and the second leg 156 may meet at an oblique angle. The arcuate leg 158 may extend between the distal ends of the first leg 154 and the second leg 156 relative to where the first leg 154 and the second leg 156 meet. Alternatively, as shown in FIGS. 6 and 7, the arcuate leg 158 may extend from the distal end of the second leg 156 to a mid-section of the first leg 154.

The first leg 154 may extend parallel to a substantially straight line from where the first leg 154 and the second leg 156 meet. Alternatively, the first leg 154 may deviate from a substantially straight line as the first leg 154 extends from where the first leg 154 and the second leg 156 meet, such that the first leg 154 has a degree of curvature. Additionally, the first leg 154 may form a divot 155 adjacent to where the arcuate leg 158 extends from the first leg 154. When the first leg 154 has a degree of curvature, the divot 155 may be formed by the portion of the first leg 154 that deviates from a substantially straight line extending from where the first leg 154 and the second leg 156 meet.

The second leg 156 may extend parallel to a substantially straight line from where the first leg 154 and the second leg 156 meet. Alternatively, the second leg 156 may deviate from a substantially straight line as the second leg 156 extends from where the first leg 154 and the second leg 156 meet, such that the second leg 156 has a degree of curvature.

The arcuate leg 158 may extend along a substantially arcuate path between the distal ends of the first leg 154 and the second leg 156, such that the arcuate leg 158 has a substantially convex profile. The arcuate leg 158 may form the toothed edge 152 that provides a series of teeth configured to mesh with a toothed circumference 137 formed by the first pinion 134.

The first sectored link 130 may define an arcuate aperture 157 that extends partially between the first leg 154 and the second leg 156. The arcuate aperture 157 may have a degree of curvature that is in alignment with a degree of curvature of the arcuate leg 158.

The first sectored link 130 may further define a vertex aperture 159 formed adjacent to where the first leg 154 and the second leg 156 meet. Further, the vertex aperture 159 may be positioned at the second pivot point 146. Moreover, the position of the vertex aperture 159 may at least partially determine the location of the second pivot point 146.

Referring again to FIGS. 6 and 7, the first sectored link 130 is pivotally attached at the first pivot point 136 to the first attachment flange 92 as described above. Specifically, the first sectored link 130 may be pivotably attached at the first pivot point 136 to the first attachment flange 92 via the first leg 154 of the first sectored link 130. Further, the first side 160 of the first sectored link 130 may be adjacent to the second surface 100 of the attachment wall 94 of the first attachment flange 92. In other words, the first side 160 of the first leg 154 may be adjacent to the second surface 100 of the attachment wall 94.

Referring still to FIGS. 6 and 7, the first mount plate 132 of the first tilt assembly 118 may have a substantially triangular shape formed by a first edge 164, a second edge 166, and a third edge 168. Further, the first mount plate 132 has a first surface 170 and a second surface 172 opposite the first surface 170. The first edge 164 and the second edge 166 may meet at a substantially 90-degree angle. Alternatively, the first edge 164 and the second edge 166 may meet at an oblique angle. The third edge 168 extends between the distal ends of the first edge 164 and the second edge 166 relative to where the first edge 164 and the second edge 166 meet.

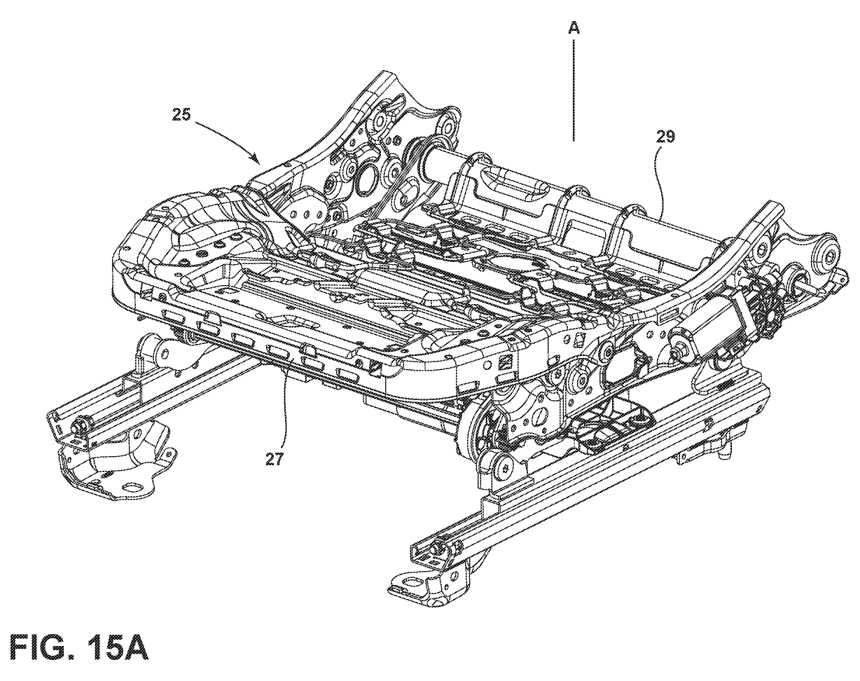

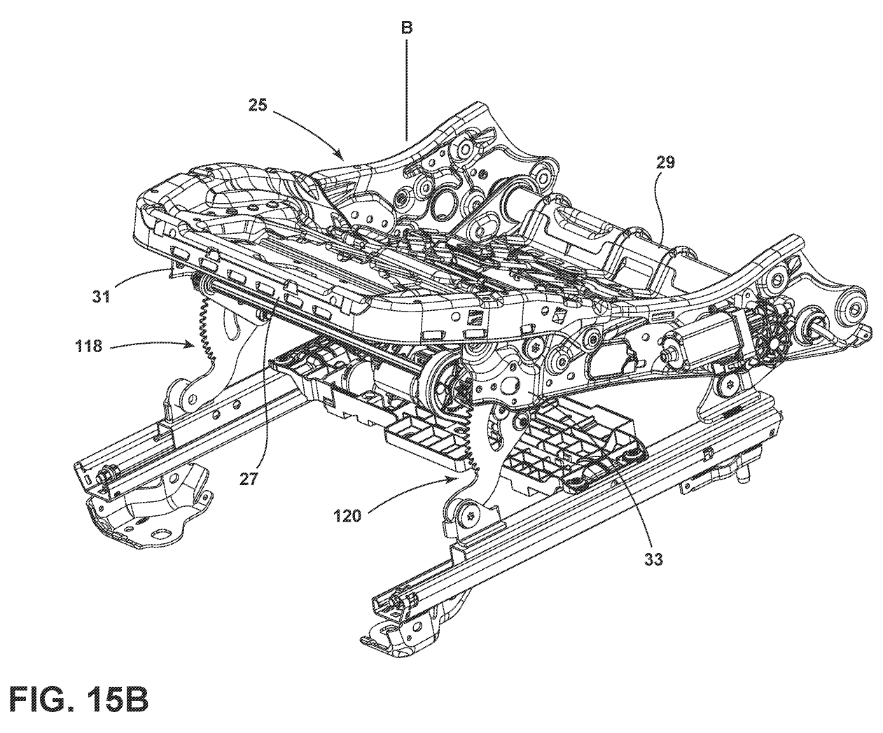

A bracket coupler 174 may be fixed to the first surface 170 of the first mount plate 132 to fix the first mount plate 132 to a first attachment skirt 31 (See FIGS. 15A and 15B) of the seat bracket 25. The bracket coupler 174 may form a substantially tubular body and define a hollow interior therethrough. Additionally, the bracket coupler 174 may extend substantially perpendicular to the first surface 170 towards the first attachment skirt 31. The bracket coupler 174 may be located adjacent to where the first 164 and the third 168 edge meet.

A pivot aperture 176 is formed through the first surface 170 of the first mount plate 132 to the second surface 172 of the first mount plate 132 forming a passage therethrough. The pivot aperture 176 may be formed adjacent to where the second edge 166 and the third edge 168 meet. Specifically, the pivot aperture 176 may be located at the second pivot point 146. Moreover, the position of the pivot aperture 176 may at least partially define the location of the second pivot point 146. As such, the pivot aperture 176 may be in substantial alignment with the vertex aperture 159 of the first sectored link 130, allowing for the first pivot bolt 148 to pivotally couple the first mount plate 132 to the first sectored link 130. As such, the first pivot bolt 148 may be interposed through both the vertex aperture 159 and the pivot aperture 176.

A stop aperture 178 may be formed through the first surface 170 of the first mount plate 132 to the second surface 172 of the first mount plate 132 forming a passage therethrough. The stop aperture 178 may be formed adjacent to the second edge 166, specifically, the stop aperture 178 may be formed substantially equidistant between the location where the second edge 166 and the third edge 168 meet and the distalmost end of the second edge 166 relative to where the second edge 166 and the third edge 168 meet.

A first stop bolt 180 may be at least partially interposed within the stop aperture 178 and may extend from the first surface 170 of the first mount plate 132 towards the second side 162 of the first sectored link 130. Specifically, the first stop bolt 180 may be at least partially disposed within the arcuate aperture 157. The first stop bolt 180 may be at least partially retained within the arcuate aperture 157 via a planar head 181 that has a first diameter greater than a second diameter spanning any two opposite points along the span of the arcuate aperture 157. As such, the first mount plate 132 may be coupled with the first sectored link 130, at least partially, via the interaction between the first stop bolt 180 and the arcuate aperture 157. Additionally, the first stop bolt 180 may be configured to translate through the arcuate aperture 157 as the first sectored link 130 pivots at the second pivot point 146 relative to the first mount plate 132. The translation of the first stop bolt 180 through the arcuate aperture 157 may function to at least partially control the pivoting of the first sectored link 130 at the second pivot point 146.

A drive aperture 182 may be formed through the first surface 170 of the first mount plate 132 to the second surface 172 of the first mount plate 132 forming a passage therethrough and is configured to receive the cross-shaft 126. The drive aperture 182 may be formed adjacent to where the first edge 164 and the second edge 166 meet.

The first pinion 134 may include a pinion tube 135 that forms a hollow interior and that extends at least partially through the drive aperture 182. The first pinion 134 may form the toothed circumference 137 configured to mesh with the toothed edge 152 of the arcuate leg 158 of the first sectored link 130. The toothed circumference 137 may define a circumferential aperture 139 that is substantially aligned with the hollow interior formed by the pinion tube 135. The toothed circumference 137 may be positioned adjacent to the first surface 170 of the first mount plate 132, and the pinion tube 135 may extend from the toothed circumference 137 through the drive aperture 182 to the second surface 172 of the first mount plate 132. Alternatively, the pinion tube 135 may extend into and be entirely disposed within the drive aperture 182.

As shown in FIGS. 6 and 7 the pivot aperture 176, the stop aperture 178, and the drive aperture 182 may be substantially aligned along an axis defined by the second edge 166 of the first mount plate 132. As such, the position of the second pivot point 146, the first stop bolt 180, and the first pinion 134 may likewise be aligned along the axis defined by the second edge 166 of the first mount plate 132.

Referring still to FIG. 6 and 7, the cross-shaft 126 may provide a series of ridges 185 circumferentially spaced and longitudinally extending at least partially the length of the cross-shaft 126. The first end 125 of the cross-shaft 126 may extend through the pinion tube 135 and through the circumferential aperture 139 of first pinion 134. The series of ridges 185 formed by the cross-shaft 126 may nest within a series of circumferentially spaced and longitudinally extending gaps formed by the interior surface of the pinion tube 135 and the interior surface of the toothed circumference 137. As such, rotation of the cross-shaft 126 about a lateral axis 129 of the cross-shaft 126 may effectuate a corresponding rotation of the first pinion 134. Additionally, the first end 125 of the cross-shaft 126 may entirely extend through the toothed circumference 137, such that a portion of the first end 125 is disposed adjacent to an exterior of the toothed circumference 137. Additionally, the first end 125 of the cross-shaft 126 may extend such that a portion of the first end 125 is disposed adjacent to the first side 160 of the first sectored link 130.

A pinion cuff 184 may be coaxially coupled around the circumference of the pinion tube 135 at the portion of the pinion tube 135 that is disposed adjacent to the second surface 172 of the first mount plate 132. Alternatively, the pinion cuff 184 may be coaxially coupled around the circumference of the first end 125 of the cross-shaft 126 and adjacent to the second surface 172 of the first mount plate 132 when the pinion tube 135 is entirely disposed within the drive aperture 182.

A first pinion ring 131 may be coaxially coupled around the first end 125 of the cross-shaft 126 and positioned adjacent to the first pinion 134. The first pinion ring 131 may function to further facilitate the rotatable coupling of the first pinion 134 to the first end 125 of the cross-shaft 126.

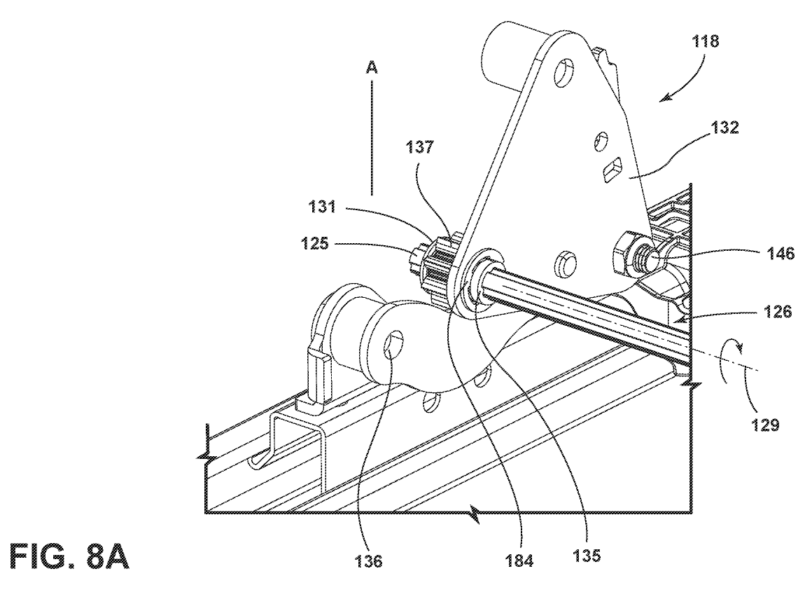

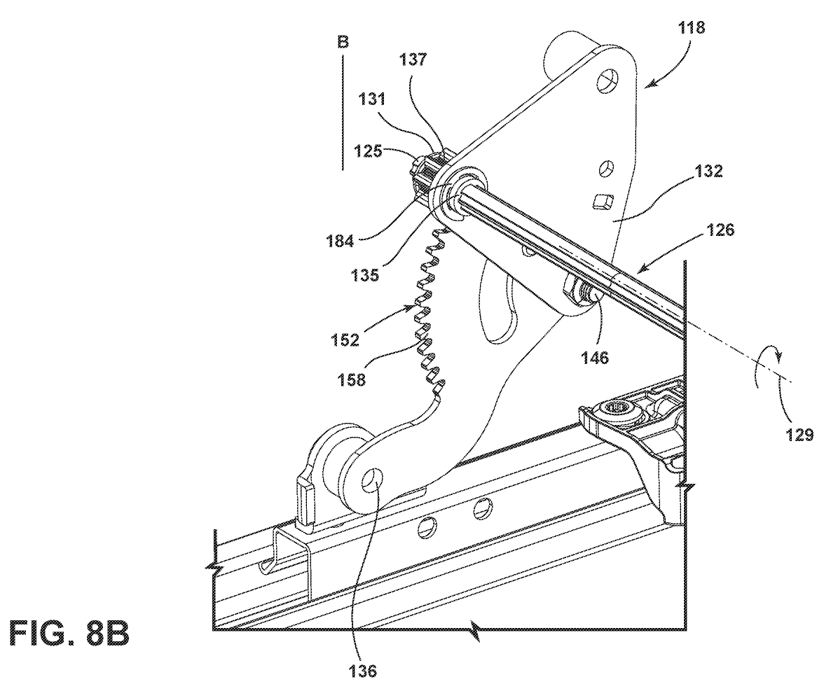

FIGS. 8A and 8B show the first tilt assembly 118 in a first position A and in a second position B, respectively. In the first position A, the user accommodation 26 may be in a neutral configuration, or in other words, in a position that is not a zero-gravity configuration. In the second position B, the user accommodation 26 may be in the zero-gravity configuration. The first tilt assembly 118 may transition from the first position A to the second position B via the clock-wise rotation of the cross-shaft 126 about the lateral axis 129 of the cross-shaft 126. As the cross-shaft 126 rotates clock-wise, the toothed circumference 137 of the first pinion 134 acts on the toothed edge 152 of the first sectored link 130 and traverses the toothed edge 152. The toothed circumference 137 may travel along the arc defined by the arcuate leg 158 towards the seat bracket 25 and towards the rear of the vehicle seating assembly 20. Substantially in union with the movement of the first pinion 134, the first sectored link 130 may travel along an arc vertically towards the seat bracket 25 and laterally towards the front of the vehicle seating assembly 20. Additionally, in union with the movement of the first sectored link 130, the first mount plate 132 may travel vertically towards the seat bracket 25 and laterally towards the rear of the vehicle seating assembly 20. The vertical and lateral movement of both the first sectored link 130 and the first mount plate 132 is facilitated by the pivoting of both the first sectored link 130 and the first mount plate 132 relative to one another about the second pivot point 146. Additionally, the vertical and lateral movement of both the first sectored link 130 and the first mount plate 132 is facilitated by the pivoting of the first sectored link 130 at the first pivot point 136. Specifically, the pivoting of the first sectored link 130 at the first pivot point 136 alters the position of the first sectored link 130 and the first mount plate 132 and accordingly, the position of the second pivot point 146.

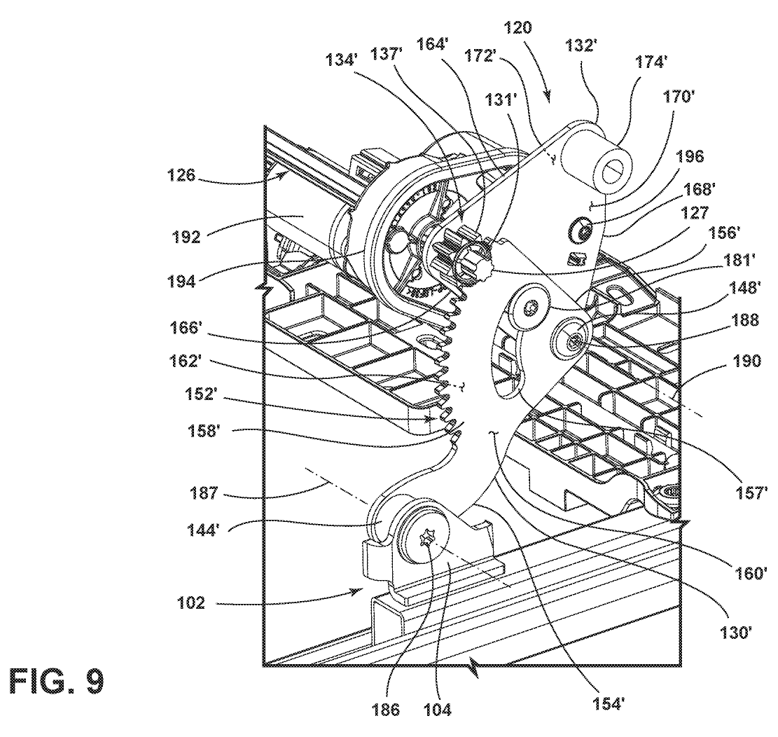

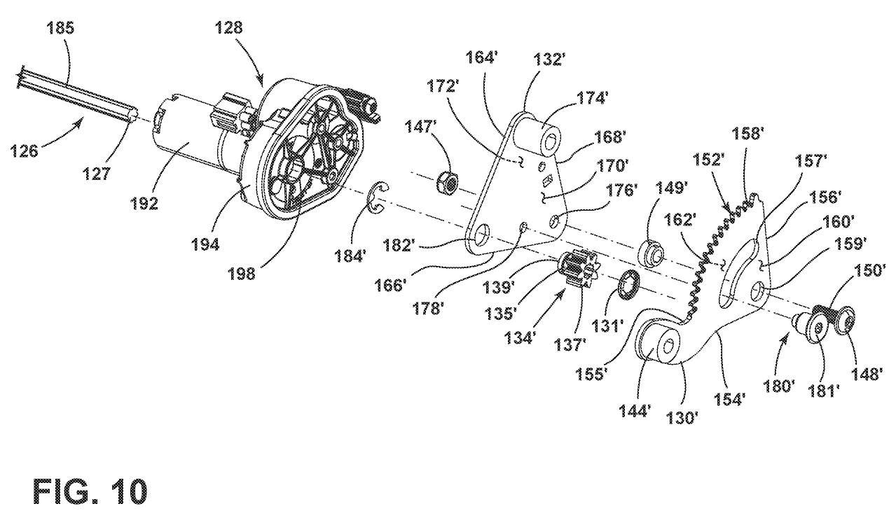

As shown in FIGS. 9 and 10, the second tilt assembly 120 is substantially identical in composition to the first tilt assembly 118. Similar components will be marked with the same numeral, but designated as belonging to the second tilt assembly 120 through the use of an apostrophe.

Referring still to FIGS. 9 and 10, the second tilt assembly 120 may include a second sectored link 130’, a second mount plate 132’, and a second pinion 134’. The second sectored link 130’ is pivotally coupled to the second attachment flange 102 at a third pivot point 186 and is configured to pivot relative to the second attachment flange 102 around a lateral axis 187 defined by the third pivot point 186. The third pivot point 186 may be formed by a bolt (not shown) that extends through the second sectored link 130’ and the second attachment flange 102, wherein the second sectored link 130’ can pivot about a shaft formed by the bolt. Alternatively, the third pivot point 186 may be formed by a second attachment bolt 140’ and a receiving aperture 144’ formed by the second sectored link 130’. The receiving aperture 144’ is configured to coaxially receive the shaft 142’ of the second attachment bolt 140’ and facilitate the pivoting of the second sectored link 130’ about the shaft 142’ through coaxial rotation of the receiving aperture 144’ about the shaft 142’ of the second attachment bolt 140’.

The second sectored link 130’ may be pivotally coupled to the second mount plate 132’ at a fourth pivot point 188 and is configured to pivot relative to the second mount plate 132’ about a lateral axis 190 defined by the fourth pivot point 188. The fourth pivot point 188 may be formed by a second pivot bolt 148’ that extends through the second sectored link 130’ and the second mount plate 132’, wherein the second sectored link 130’ and the second mount plate 132’ may pivot about a pivot shaft 150’ formed by the second pivot bolt 148’. A second interlink 149’ may be coaxially disposed on the second pivot bolt 148’ at the portion of the second pivot bolt 148’ that extends between the second sectored link 130’ and the second mount plate 132’. Also, a second washer ‘147 may be coaxially disposed on the portion of the second pivot bolt ‘148 that extends through the second mount plate ‘132. Additionally, the second mount plate 132’ may be configured to pivot at the fourth pivot point 188 relative to the second sectored link 130’. The second pinion 134’ may be rotatably fixed to the second mount plate 132’ to engage and rotate against a toothed edge 152’ of the second sectored link 130’.

Referring still to FIGS. 9 and 10, the second sectored link 130’ of the second tilt assembly 120 may have a substantially triangular shape formed by a first leg 154’, a second leg 156’, and an arcuate leg 158’. Further, the second sectored link 130’ has a first side 160’ and a second side 162’ opposite the first side 160’. The first leg 154’ and the second leg 156’ may meet at a substantially 90-degree angle. Alternatively, the first leg 154’ and the second leg 156’ may meet at an oblique angle. The arcuate leg 158’ may extend between the distal ends of the first leg 154’ and the second leg 156’ relative to where the first leg 154’ and the second leg 156’ meet. Alternatively, the arcuate leg 158’ may extend from the distal end of the second leg 156’ to a mid-section of the first leg 154’.

The first leg 154’ may extend parallel to a substantially straight line from where the first leg 154’ and the second leg 156’ meet. However, the first leg 154’ may deviate from a substantially straight line as the first leg 154’ extends from where the first leg 154’ and the second leg 156’ meet, such that the first leg 154’ has a degree of curvature. Additionally, the first leg 154’ may form a divot 155’ adjacent to where the arcuate leg 158’ extends from the first leg 154’. When the first leg 154’ has a degree of curvature, the divot 155’ may be formed by the portion of the first leg 154’ that deviates from a substantially straight line extending from where the first leg 154’ and the second leg 156’ meet.

The second leg 156’ may extend parallel to a substantially straight line from where the first leg 154’ and the second leg 156’ meet. However, the second leg 156’ may deviate from a substantially straight line as the second leg 156’ extends from where the first leg 154’ and the second leg 156’ meet, such that the second leg 156’ has a degree of curvature.

The arcuate leg 158’ may extend along a substantially arcuate path between the distal ends of the first leg 154’ and the second leg 156’, such that the arcuate leg 158’ has a substantially convex profile. The arcuate leg 158’ may form the toothed edge 152’ that provides a series of teeth configured to mesh with a toothed circumference 137’ provided by the second pinion 134’.

The second sectored link 130’ may define an arcuate aperture 157’ that extends partially between the first leg 154’ and the second leg 156’. The arcuate aperture 157’ may have a degree of curvature that is in alignment with a degree of curvature of the arcuate leg 158’.

The second sectored link 130’ may further define a vertex aperture 159’ formed adjacent to where the first leg 154’ and the second leg 156’ meet. Further, the vertex aperture 159’ is positioned at the fourth pivot point 188. Moreover, the position of the vertex aperture 159’ at least partially determines the location of the fourth pivot point 188.

Referring to FIGS. 9 and 10, the second sectored link 130’ is pivotally attached at the third pivot point 186 to the second attachment flange 102 as described above. Specifically, the second sectored link 130’ is pivotably attached at the third pivot point 186 to the second attachment flange 102 via the first leg 154’ of the second sectored link 130’. Further, the first side 160’ of the second sectored link 130’ is adjacent to the second surface 100’ of the attachment wall 104 of the second attachment flange 102. In other words, the first side 160’ of the first leg 154’ is adjacent to the second surface 100’ of the attachment wall 104.

Referring still to FIGS. 9 and 10, the second mount plate 132’ of the second tilt assembly 120 may have a substantially triangular shape formed by a first edge 164’, a second edge 166’, and a third edge 168’. Further, the second mount plate 132’ has a first surface 170’ and a second surface 172’. The first edge 164’ and the second edge 166’ may meet at a substantially 90-degree angle. Alternatively, the first 164’ and the second 166’ edge may meet at an oblique angle. The third edge 168’ extends between the distal ends of the first 164’ and the second 166’ edge relative to where the first edge 164’ and the second edge 166’meet.

A bracket coupler 174’ may be fixed to the first surface 170’ of the second mount plate 132’ to fix the second mount plate 132’ to a second attachment skirt 33 (see FIG. 15) of the seat bracket 25. The bracket coupler 174’ may form a substantially tubular body and define a hollow interior therethrough. Additionally, the bracket coupler 174’ may extend substantially perpendicular to the first surface 170’ towards the second attachment skirt 33. The bracket coupler 174’ may be located adjacent to where the first edge 164’ and the third edge 168’ meet.

A pivot aperture 176’ is formed through the first surface 170’ of the second mount plate 132’ to the second surface 172’ of the second mount plate 132’ forming a passage therethrough. The pivot aperture 176’ may be formed adjacent to where the second 166’ and the third 168’ edge meet. Specifically, the pivot aperture 176’ may be located at the fourth pivot point 188. Moreover, the position of the pivot aperture 176’ may at least partially define the location of the fourth pivot point 188. As such, the pivot aperture 176’ may be in substantial alignment with the vertex aperture 159’ of the second sectored link 130’, allowing for the second pivot bolt 148’ to pivotally couple the second mount plate 132’ to the second sectored link 130’. As such, the second pivot bolt 148’ may be interposed through both the vertex aperture 159’ and the pivot aperture 176’.

A stop aperture 178’ may be formed through the first surface 170’ of the second mount plate 132’ to the second surface 172’ of the second mount plate 132’, forming a passage therethrough. The stop aperture 178’ may be formed adjacent to the second edge 166’ and may be positioned substantially equidistant between the location where the second edge 166’ and the third edge 168’ meet and the distalmost end of the second edge 166’ relative to where the second edge 166’ and the third edge 168’ meet.

A second stop bolt 180’ may be at least partially interposed within the stop aperture 178’ and may extend from the first surface 170’ of the second mount plate 132’ towards the second side 162’ of the second sectored link 130’. Specifically, the second stop bolt 180’ may be at least partially disposed within the arcuate aperture 157’. The second stop bolt 180’ may be at least partially retained within the arcuate aperture 157’ via a planar head 181’ that has a first diameter greater than a second diameter that spans between any two opposite points along the length of the arcuate aperture 157’. As such, the second mount plate 132’ is coupled with the second sectored link 130’, at least partially, via the interaction between the second stop bolt 180’ and the arcuate aperture 157’. Additionally, the second stop bolt 180’ may be configured to translate through the arcuate aperture 157’ as the second sectored link 130’ pivots at the fourth pivot point 188. The translation of the second stop bolt 180’ through the arcuate aperture 157’ may function to at least partially control the pivoting of the second sectored link 130’ about the fourth pivot point 188.

A drive aperture 182’ may be formed through the first surface 170’ of the second mount plate 132’ to the second surface 172’ of the second mount plate 132’ forming a passage therethrough. The drive aperture 182’ may be formed adjacent to where the first edge 164’ and the second edge 166’ meet.

The second pinion 134’ may include a pinion tube 135’ that forms a hollow interior that extends at least partially through the drive aperture 182’. The second pinion 134’ may form the toothed circumference 137’ configured to mesh with the toothed edge 152’ of the arcuate leg 158’ of the second sectored link 130’. The toothed circumference 137’ may define a circumferential aperture 139’ that is substantially aligned with the hollow interior of the pinion tube 135’. Additionally, the toothed circumference 137’ may be positioned adjacent to the first surface 170’ of the second mount plate 132’ and the pinion tube 135’ may extend from the toothed circumference 137’ through the drive aperture 182’ to the second surface 172’ of the second mount plate 132’. Alternatively, the pinion tube 135’ may extend into and be entirely disposed within the drive aperture 182’.

As shown in FIG. 10, the pivot aperture 176’, the stop aperture 178’, and the drive aperture 182’ may be substantially aligned along an axis defined by the second edge 166’ of the second mount plate 132’. As such, the position of the fourth pivot point 188, the second stop bolt 180’, and the second pinion 134’ may likewise be aligned along an axis defined by the second edge 166’ of the second mount plate 132’.

Referring now to FIGS. 9 and 10, the second end 127 of the cross-shaft 126 may extend through the pinion tube 135’ and through the circumferential aperture 139’ of the toothed circumference 137’. The series of ridges 185 formed by the cross-shaft 126 may nest within a series of circumferentially spaced and longitudinally extending gaps formed by the interior surface of the pinion tube 135’ and the interior surface of the toothed circumference 137’. As such, rotation of the cross-shaft 126 about a lateral axis 129 of the cross-shaft 126 may effectuate a corresponding rotation of the second pinion 134’. Additionally, the second end 127 of the cross-shaft 126 may entirely extend through the toothed circumference 137’, such that a portion of the second end 127 is disposed adjacent to an exterior of the toothed circumference 137’. Additionally, the second end 127 of the cross-shaft 126 may extend such that a portion of the second end 127 is disposed adjacent to the first side 160’ of the second sectored link 130’.

A pinion cuff 184’ may be coaxially coupled around the circumference of the pinion tube 135’ at the portion of the pinion tube 135’ that is disposed adjacent to the second surface 172’ of the second mount plate 132’. Alternatively, the pinion cuff 184’ may be coaxially coupled around the circumference of the second end 127 of the cross-shaft 126 and adjacent to the second surface 172’ of the second mount plate 132’ when the pinion tube 135’ is entirely disposed within the drive aperture 182’.

A second pinion ring 131’ may be coaxially coupled around the second end 127 of the cross-shaft 126 and positioned adjacent to the second pinion 134’. The second pinion ring 131’ may function to further facilitate the rotatable coupling of the second pinion 134’ to the second end 127 of the cross-shaft 126.

As shown in FIGS. 9 and 10, the actuator 128 may include a gearbox 192 and an electric motor 194 mechanically linked with the gearbox 192. The motor 194 and the gearbox 192 may be positioned adjacent to the second surface 172’ of the second mount plate 132’ of the second tilt assembly 120. Alternatively, the motor 194 and the gearbox 192 may be positioned adjacent to the second surface 172 of the first mount plate 132 of the first tilt assembly 118. The motor 194 may be fixed to the second surface 172’ of the second mount plate 132’ via a motor bolt 196.

The motor 194 may define a motor aperture 198 and the cross-shaft 126 may extend through the motor aperture 198 such that the motor 194 is coaxially coupled with the cross-shaft 126. The interior surface of the motor aperture 198 may define a series of circumferentially spaced and longitudinally extending gaps such that the series of ridges 185 formed by the cross-shaft 126 may nest within the series of circumferentially spaced and longitudinally extending gaps. The motor 194 may be coaxially coupled with the second end 127 of the cross-shaft 126, such that the second end 127 of the cross-shaft 126 may extend through the motor aperture 198 and be disposed within the interiors of the pinion tube 135’, the drive aperture 182’, and the toothed circumference 137’ as described above. Accordingly, a rotation of the cross-shaft 126 effectuates a rotation of the second pinion 134’.

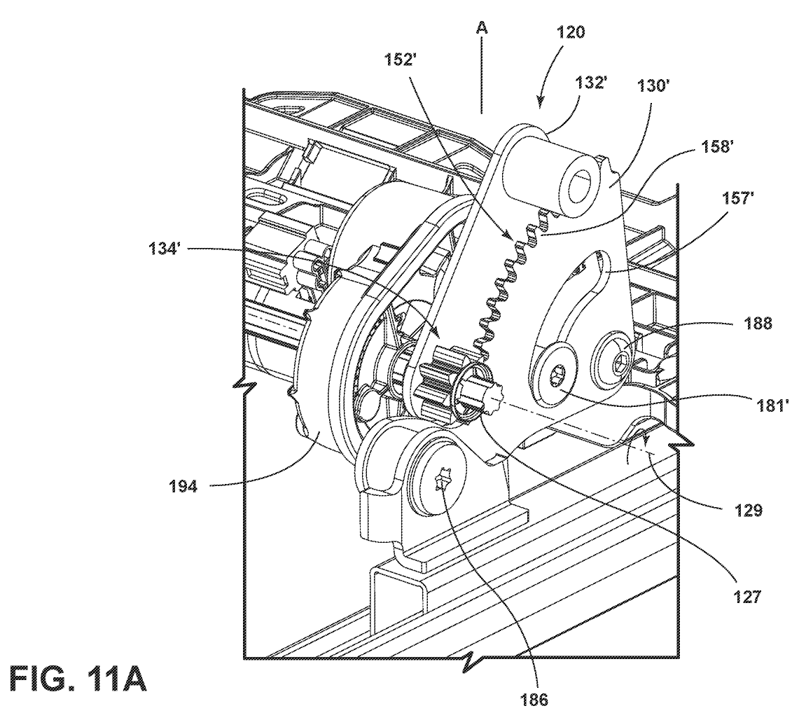

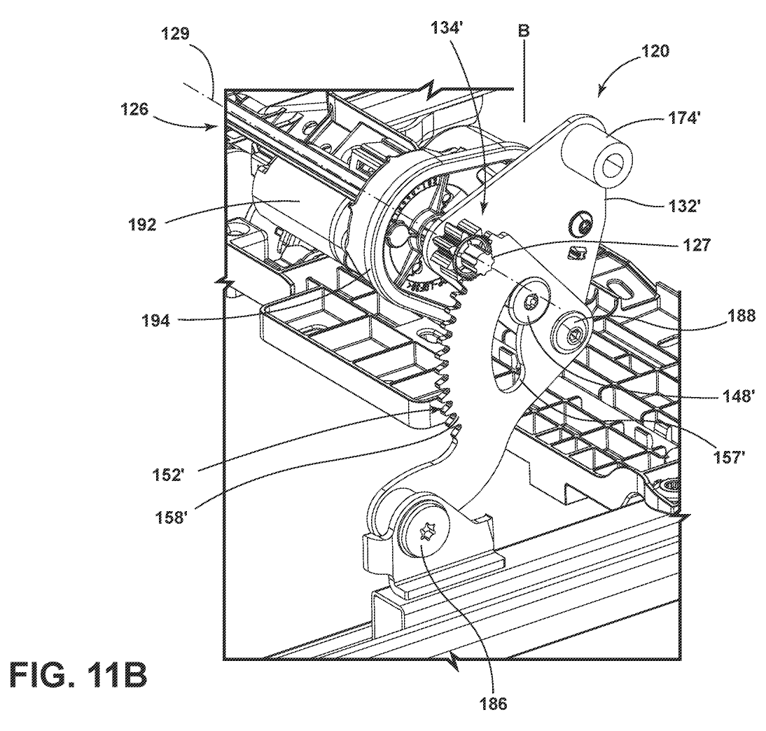

FIGS. 11A and 11B show the second tilt assembly 120 in a first position A and a second position B, respectively. In the first position A, the user accommodation 26 may be in a neutral configuration, or in other words, in a position that is not a zero-gravity configuration. In the second position B, the user accommodation 26 may be in the zero-gravity configuration. The second tilt assembly 120 may transition from the first position A to the second position B via the clock-wise rotation of the cross-shaft 126. As the cross-shaft 126 rotates clock-wise, the toothed circumference 137’ of the second pinion 134’ acts on the toothed edge 152’ of the second sectored link 130’ and traverses the toothed edge 152’. The toothed circumference 137’ may travel along the arc defined by the arcuate leg 158’ towards the seat bracket 25 and towards the rear of the vehicle seating assembly 20. Substantially in union with the movement of the second pinion 134’, the second sectored link 130’ may travel along an arc vertically towards the seat bracket 25 and laterally towards the front of the vehicle seating assembly 20. Additionally, in union with the movement of the second sectored link 130’, the second mount plate 132’ may travel vertically towards the seat bracket 25 and laterally towards the rear of the vehicle seating assembly 20. The vertical and lateral movement of both the second sectored link 130’ and the second mount plate 132’ is facilitated by the pivoting of both the second sectored link 130’ and the second mount plate 132’ relative to one another about the fourth pivot point 188. Additionally, the vertical and lateral movement of both the second sectored link 130’ and the second mount plate 132’ is facilitated by the pivoting of the second sectored link 130’ at the third pivot point 186. Specifically, the pivoting of the second sectored link 130’ at the third pivot point 186 alters the position of the second sectored link 130’ and the second mount plate 132’, and accordingly, the position of the fourth pivot point 188.

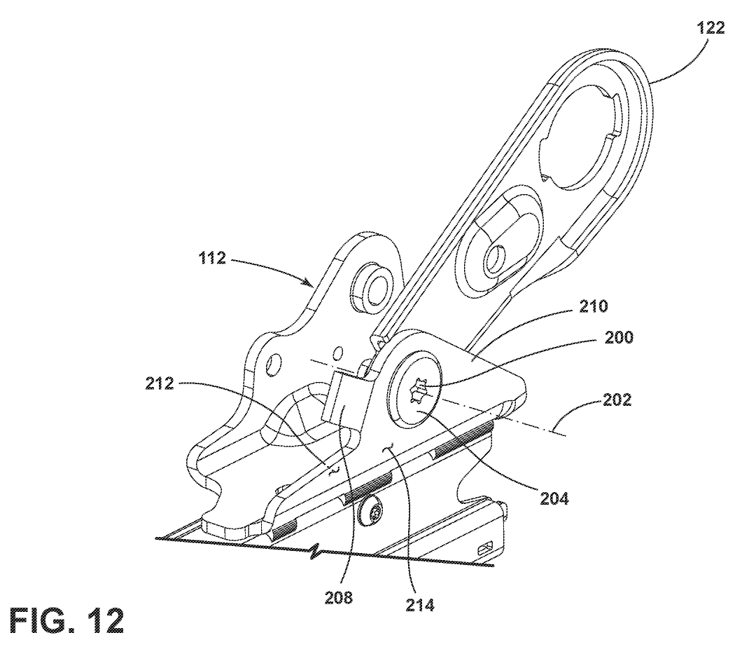

Referring now to FIG. 12, the pivotable link 122 is pivotally coupled to the third attachment flange 112 at a fifth pivot point 200 and is configured to pivot relative to the third attachment flange 112 about a lateral axis 202 defined by the fifth pivot point 200. The fifth pivot point 200 may be formed by a pivotable link bolt 204 that extends through the pivotable link 122 and the third attachment flange 112, wherein the pivotable link 122 can pivot about a bolt shaft (not shown) formed by the pivotable link bolt 204. The third attachment flange 112 may form a stop flange 208 and an attachment wall 210 that provides a first surface 212 and a second surface 214. The pivotable link 122 may be pivotally coupled with the first surface 212 of the attachment wall 210 of the third attachment flange 112 Specifically, the pivotable link 122 may be pivotally coupled and adjacent to the first surface 212 of the attachment wall 210.

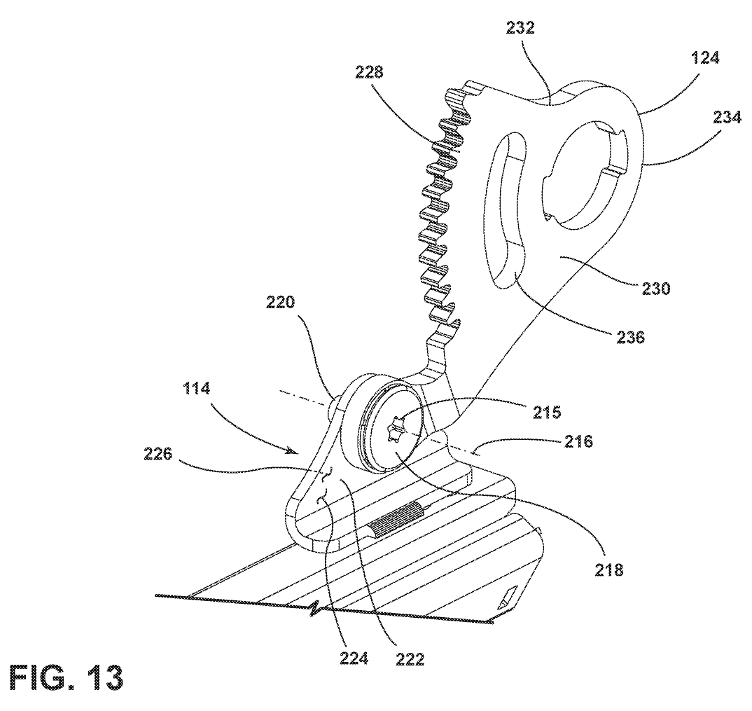

Referring now to FIG. 13, the rear sectored link 124 is pivotally coupled to the fourth attachment flange 114 at a sixth pivot point 215 and is configured to pivot relative to the fourth attachment flange 114 about a lateral axis 216 defined by the sixth pivot point 215. The sixth pivot point 215 may be formed by a rear link bolt 218 that extends through the rear sectored link 124 and the fourth attachment flange 114, wherein the rear sectored link 124 can pivot about a bolt shaft 220 formed by the rear link bolt 218. The fourth attachment flange 114 may form an attachment wall 222 that provides a first surface 224 and a second surface 226. The rear sectored link 124 may be pivotally coupled with the first surface 224 of the attachment wall 222 of the fourth attachment flange 114. Specifically, the rear sectored link 124 may be pivotally coupled and adjacent to the first surface 224 of the attachment wall 222.

The rear sectored link 124 may form a toothed arcuate edge 228 that extends between a first leg 230 and a second leg 232. The first leg 230 and the second leg 232 may together form a convex portion 234 where the first leg 230 and the second leg 232 meet. The rear sectored link 124 may be pivotally coupled to the fourth attachment flange 114 via the first leg 230. Additionally, a rear arcuate aperture 236 is defined by the rear sectored link 124. The rear arcuate aperture 236 may define a curvature that is substantially aligned with a curvature of the toothed arcuate edge 228.

In operation, both the pivotable link 122 and the rear sectored link 124 may pivot substantially in union as the user accommodation 26 is transitioned to the zero-gravity configuration. Specifically, both the pivotable link 122 and the rear sectored link 124 may pivot vertically away from the seat bracket 25 and laterally towards the rear of the vehicle 22 such that the user accommodation 26 may be oriented into the zero-gravity configuration.

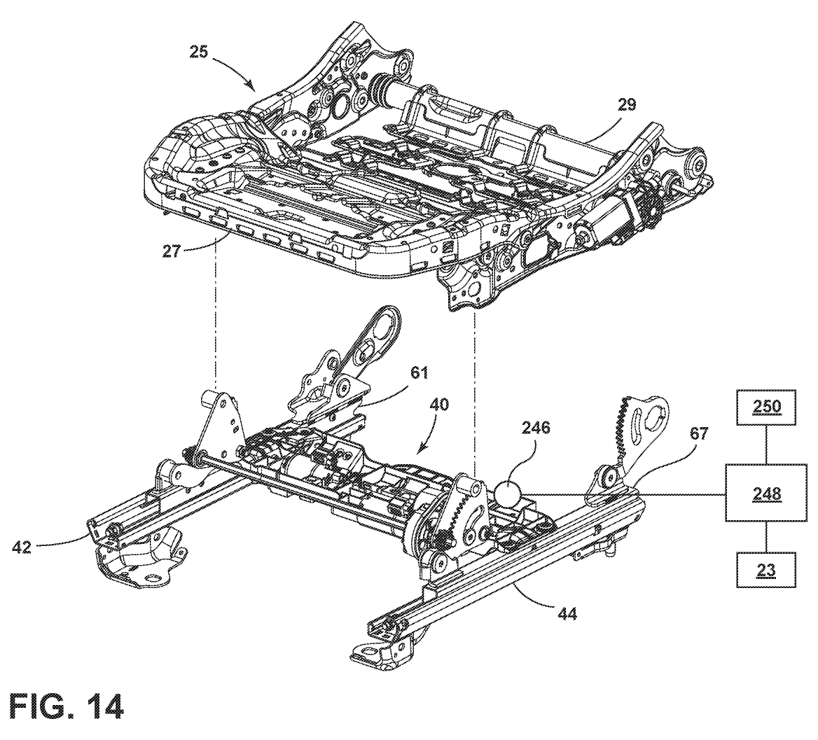

Referring now to FIG. 14, at least one sensing mechanism 246 may be configured to detect the position of the insertion track 40 relative to the first receiving track 42 and the second receiving track 44. The sensing mechanism 246 is in electronic communication with a vehicle controller 248, which may be a dedicated seat controller or other vehicle controller, that is in further electronic communication with a seat control 250 configured to control the operation of the actuator 128. The vehicle controller 248 may be configured to prevent the transition of the user accommodation 26 to the zero-gravity position when the rear portion 61, 67 of the insertion track 40 has not been translated past a predetermined position threshold. The predetermined position threshold may represent the position of the insertion track 40 relative to the first 42 and the second 44 receiving tracks necessary to allow for the rear portion 29 of the seat bracket 25 to tilt towards the floor 24 of the vehicle 22 without contacting the first 42 and the second 44 receiving tracks. The seat control 250 may be a user input toggle located on the vehicle seating assembly 20. Alternatively, or in addition, the seat control 250 may be present on a user interface (not shown), such as a touchscreen present on a vehicle console.

Still referring to FIG. 14, the vehicle controller 248 may be in electronic communication with the gear selector 23 of the vehicle 22 and configured to prevent the transition of the user accommodation 26 to the zero-gravity position when the vehicle 22 is in any drive mode other than park when the user accommodation 26 is in use by the driver of the vehicle 22. Additionally, the vehicle controller 248 may be configured to prevent the transition of the user accommodation 26 to the zero-gravity position when the vehicle 22 is not in an autonomous drive mode when the user accommodation 26 is in use by an operator of the vehicle 22.

Referring specifically to FIG. 15 and the aforementioned figures, a description of the operation of the zero-gravity drive mechanism will now be detailed. A user of the vehicle 22 may activate the seat control 250 on a user interface of the vehicle 22 and/or on a portion of the user accommodation 26 to transition the user accommodation 26 from a neutral configuration A into a zero-gravity configuration B. The vehicle controller 248 may determine whether the orientation of the user accommodation 26 and the driving state of the vehicle 22 allow for the transition of the user accommodation 26 to the zero-gravity configuration B. If the vehicle controller 248 determines that the transition is appropriate to proceed, the motor 194 will activate and drive the cross-shaft 126 to rotate clock-wise about the lateral axis 129 of the cross-shaft 126 as shown in FIGS. 8 and 11. As the cross-shaft 126 rotates, the first pinion 134 of the first tilt assembly 118 and the second pinion 134’ of the second tilt assembly 120 will begin to rotate clock-wise in tandem, as the cross-shaft 126 exerts a substantially equivalent rotational force against both pinions 134, 134’ through the engagement of the series of ridges 185 of the cross-shaft 126 with the gaps formed in the interior of the pinion tubes 135, 135’. The toothed circumference 137, 137’ of both pinions 134, 134’ ascends the toothed edge 152, 152’ of the arcuate leg 158, 158’ of the respectively coupled sectored links 130, 130’ of the first tilt assembly 118 and the second tilt assembly 120. As the pinions 134, 134’ ascend, each mount plate 132, 132’ pivots at the respective pivot points 146, 188 relative to the respective sectored link 130, 130’. Each mount plate 132, 132’ is driven vertically towards the seat bracket 25 and laterally towards the rear of the vehicle seating assembly 20 as a function of the curvature of the arcuate leg 158, 158’ of each sectored link 130, 130’. As the mount plates 132, 132’ pivot from the respective sectored link 130, 130’, the sectored links 130, 130’ both pivot at the respective pivot points 136, 186 relative to the respective attachment flange 92, 102, pivoting vertically towards the seat bracket 25, and laterally towards the front of the vehicle seating assembly 20. Both the pivotable link 122 and the rear sectored link 124 simultaneously pivot in coordination with the first tilt assembly 118 and the second tilt assembly 120 vertically towards the floor 24 of the vehicle 22 and laterally towards the rear of the vehicle seating assembly 20. As such, the first tilt assembly 118 and the second tilt assembly 120 tilt the front portion 27 of the seat bracket 25 vertically towards the roof of the vehicle 22 and laterally towards the rear of the vehicle 22. The pivotable link 122 and the rear sectored link 124 together tilt the rear portion 29 of the seat bracket 25 vertically towards the floor 24 of the vehicle 22, and laterally towards the rear of the vehicle 22. Together, the first tilt assembly 118, the second tilt assembly 120, the pivotable link 122, and the rear sectored link 124 tilt the seat bracket 25 to allow for the user accommodation 26 to enter into the zero-gravity configuration B.

Referring back to FIG. 1, as the seat bracket 25 is transitioned to the zero-gravity configuration by the zero-gravity mechanism 116, the seat back 30 may be translated into a recline position by a seat back actuator. The seat back actuator may be linked with the seat control 250 and configured to activate simultaneously with an activation of the actuator 128 of the zero-gravity mechanism 116. Alternatively, or in addition, the seat back actuator may be controllable independently from the actuator 128. Also, the seat back 30 may transition into the zero-gravity configuration as a function of the position of the seat back 30 at the rear portion 29 of the seat bracket 25. Specifically, the seat back 30 may move laterally towards the rear of the vehicle 22 and vertically towards the floor 24 of the vehicle 22 as the seat bracket 25 is tilted by the zero-gravity mechanism 116.

Referring still to FIG. 1, as the seat bracket 25 is transitioned to the zero-gravity configuration by the zero-gravity mechanism 116, the leg support 18 may be translated into a recline position by a leg support actuator. The leg support actuator may be linked with the seat control 250 and configured to activate simultaneously with an activation of the actuator 128 of the zero-gravity mechanism 116. Alternatively, or in addition, the leg support actuator may be controllable independently from the actuator 128. Also, the leg support 18 may transition into the zero-gravity configuration as a function of the position of the leg support 18 at the front portion 27 of the seat bracket 25. Specifically, the leg support 18 may move laterally towards the front of the vehicle 22 and vertically upwards towards the roof of the vehicle 22 as the seat bracket 25 is tilted by the zero-gravity mechanism 116.

It is to be understood that variations and modifications can be made to the aforementioned structure without departing from the concepts of the present disclosure, and further it is to be understood that such concepts are intended to be covered by the following claims unless these claims by their language expressly state otherwise.

What is claimed is:

1. A vehicle seating assembly comprising:
a seat base;
a seat back;
an insertion track;
a cross-shaft with a first end and a second end;
a first mount plate coupled to the first end of the cross-shaft; and
a first sectored link coupled to the first end of the cross-shaft, wherein;
the first sectored link is pivotally coupled to the insertion track at a first
pivot point; and
the first sectored link is pivotally coupled to the first mount plate at a second pivot point, and wherein the first sectored link is configured to move the seat base between a neutral configuration and a zero-gravity configuration.

2. The vehicle seating assembly of claim 1 further comprising:
a second mount plate coupled to the second end of the cross-shaft;
a second sectored link coupled to the second end of the cross-shaft, wherein:
the second sectored link is pivotally coupled to the insertion track at a third pivot point; and
the second sectored link is pivotally coupled to the second mount plate at a fourth pivot point.

3. The vehicle seating assembly of claim 1, wherein the first sectored link is pivotally coupled to a front portion of the insertion track.

4. The vehicle seating assembly of claim 1, wherein the first mount plate is coupled to a seat bracket.

5. The vehicle seating assembly of claim 1, wherein the first sectored link has an arcuate leg that defines a toothed edge configured to mesh with a first pinion coupled to the first end of the cross-shaft.

6. The vehicle seating assembly of claim 1, wherein the first sectored link defines an arcuate aperture.

7. The vehicle seating assembly of claim 1, wherein the first mount plate defines a drive aperture that extends between a first side of the first mount plate and a second side of the first mount plate, wherein a first pinion is coupled with the first side of the first mount plate, and the first end of the cross-shaft is coupled with the first pinion via the drive aperture.

8. The vehicle seating assembly of claim 1, further comprising an actuator coupled to the cross-shaft and configured to rotate the cross-shaft about a lateral axis defined by the cross-shaft.

9. The vehicle seating assembly of claim 1, further comprising a first pinion coupled with the first end of the cross-shaft, a second pinion coupled with the second end of the cross-shaft, and an actuator coupled with the cross-shaft.

10. The vehicle seating assembly of claim 1, further comprising a first stop bolt coupled with a first side of the first mount plate and interposed between the second pivot point and a first pinion.

11. The vehicle seating assembly of claim 10, wherein the first stop bolt, the second pivot point, and the first pinion are substantially aligned along an axis defined by a second edge of the first mount plate.

12. A vehicle seating assembly comprising:
a seat base;
a seat back;
an insertion track;
a cross-shaft with a first end and a second end;
a first mount plate coupled to the first end of the cross-shaft;
a second mount plate coupled to the second end of the cross-shaft;
a first sectored link coupled to the first end of the cross-shaft, wherein:
the first sectored link is pivotally coupled to the insertion track at a first pivot point; and
the first sectored link is pivotally coupled to the first mount plate at a second pivot point; and
a second sectored link coupled to the second end of the cross-shaft, wherein:
the second sectored link is pivotally coupled to the insertion track at a third pivot point; and
the second sectored link is pivotally coupled to the second mount plate at a fourth pivot point, and wherein the first and second sectored links are configured to move the seat base between a neutral configuration and a zero-gravity configuration.

13. The vehicle seating assembly of claim 12, wherein the first sectored link and the second sectored link are pivotally coupled to a front portion of the insertion track.

14. The vehicle seating assembly of claim 12, wherein the first mount plate and the second mount plate are coupled to a seat bracket.

15. The vehicle seating assembly of claim 12 further comprising a first pinion coupled with the first end of the cross-shaft and a second pinion coupled with the second end of the cross-shaft.

16. The vehicle seating assembly of claim 12 further comprising an actuator coupled to the cross-shaft and configured to rotate the cross-shaft about a lateral axis defined by the cross-shaft.

17. The vehicle seating assembly of claim 12, wherein the first sectored link is configured to pivot about a lateral axis defined by the first pivot point and to pivot about a lateral axis defined by the second pivot point, and wherein the second sectored link is configured to pivot about a lateral axis defined by the third pivot point and to pivot about a lateral axis defined by the fourth pivot point.

18. A vehicle seating assembly comprising:
a sliding assembly;
a seat bracket;
a cross-shaft with a first end and a second end;
a first mount plate coupled to the first end of the cross-shaft and the seat bracket; and
a first sectored link coupled to the first end of the cross-shaft, wherein;
the first sectored link is pivotally coupled to the sliding assembly at a first pivot point; and
the first sectored link is pivotally coupled to the first mount plate at a second pivot point, and wherein the first sectored link and the sliding assembly are configured to move the seat base between a neutral configuration and a zero-gravity configuration.

19. The vehicle seating assembly of claim 18, further comprising:
a second mount plate coupled to the second end of the cross-shaft and the seat bracket;
a second sectored link coupled to the second end of the cross-shaft, wherein:
the second sectored link is pivotally coupled to the sliding assembly at a third pivot point; and
the second sectored link is pivotally coupled to the second mount plate at a fourth pivot point.

20. The vehicle seating assembly of claim 19, further comprising:
a first pinion coupled to the first end of the cross-shaft and meshed with a
toothed edge of the first sectored link;
a second pinion coupled to the second end of the cross-shaft and meshed with a
toothed edge of the second sectored link; and
an actuator coupled to the second end of the cross-shaft, wherein the actuator is
configured to rotate the cross-shaft about a lateral axis defined by the cross-shaft to tilt a
front portion of the seat bracket from a first position to a second position.
